(19) United States
(12) Patent Application Publication
(10) Pub. No.: US 2008/0080083 A1
(43) Pub. Date: Apr. 3, 2008

(54) METHODS AND SYSTEMS FOR A READER/WRITER SELECTIVELY POSITIONABLE INSIDE AND OUTSIDE A CHASSIS

(76) Inventors: Steven S. HOMER, Houston, TX (US); Jeffrey A. Lev, Houston, TX (US); Earl W. Moore, Houston, TX (US); Bun Chay Te, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/537,475

(22) Filed: Sep. 29, 2006

(51) Int. Cl. G11B 5/09

(52) U.S. Cl. 360/51

(57) ABSTRACT

A computer system is provided, the computer system having a chassis that encloses a processor and a system memory. The computer system further comprises a reader/writer selectively positionable between a storage position inside the chassis and an operational position outside the chassis.

### BACKGROUND

In laptop computers, limited space is available for the printed circuit board (PCB) and other components. Thus, positioning system components such as a hard drive, an optical drive, and a battery becomes difficult. Although larger size laptops could alleviate the positioning difficulties, many consumers prefer smaller and lighter laptops

### BRIEF DESCRIPTION OF THE DRAWINGS

For a detailed description of exemplary embodiments of the invention, reference will now be made to the accompanying drawings in which:

FIG. 1 shows a device in accordance with embodiments;

FIG. 2 shows a system in accordance with embodiments;

FIG. 3 shows another system in accordance with alternative embodiments;

FIG. 4 shows an optical drive in accordance with embodiments; and

FIG. 5 illustrates a method in accordance with embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not functions. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. Also, the term “reader/writer” is intended to mean a device that only reads data from a storage medium, a device that only writes data to a storage medium and/or a device that reads data from and writes data to a storage medium.

### DETAILED DESCRIPTION

Embodiments provide a reader/writer that is selectively stored within a device chassis or housing. The reader/writer may be, for example, an optical drive that reads/writes optical disks such as CD-ROMs or DVD-ROMs. As needed, the reader/writer is positionable external to the device chassis to perform read/write operations. For example, the reader/writer could pivot between an internal storage position (within the chassis) and an external operational position (outside the chassis). Additionally or alternatively, the reader/writer could slide between an internal storage position and an external operational position. In at least some embodiments, the device implementing the reader/writer does not allocate space within the chassis for the storage medium associated with the reader/writer (e.g. an optical disk is associated with an optical drive). Also, the reader/writer can be sized and shaped to diminish the amount of space which the reader/writer occupies within the chassis while in the internal storage position.

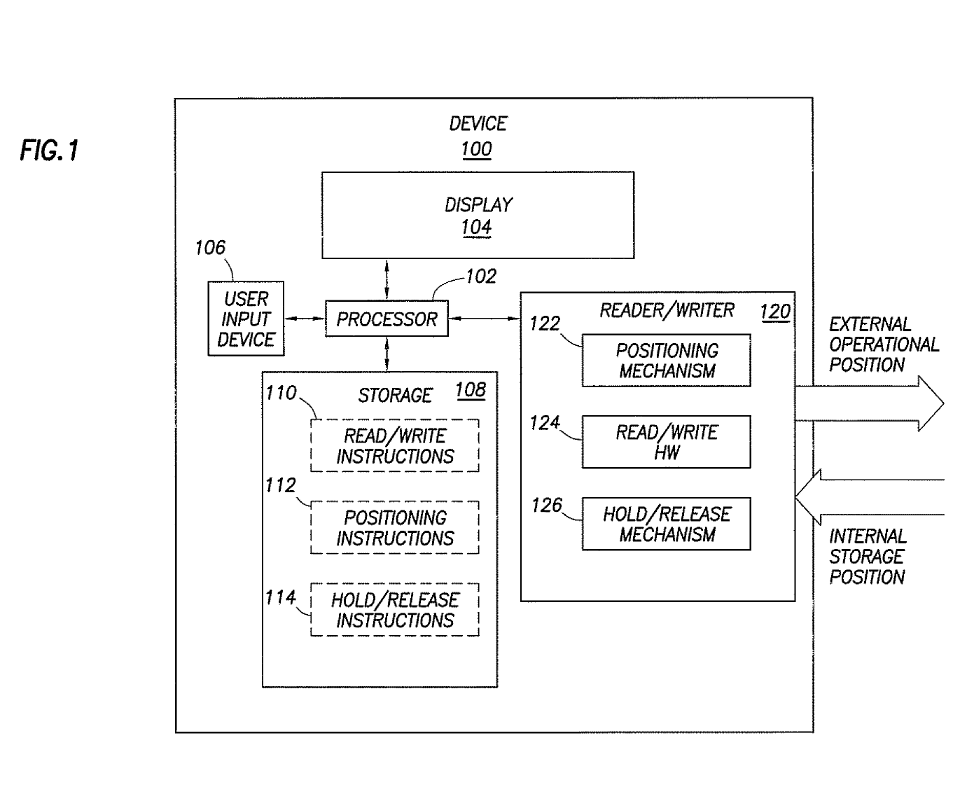

FIG. 1 shows a device 100 in accordance with embodiments. The device 100 may be, for example, a laptop computer or other mobile device having limited space within a device chassis or housing. As shown in FIG. 1, the device 100 comprises a processor 102 coupled to a display 104. The display 104 may be, for example, a Liquid Crystal Display (LCD) panel capable of presenting text, shapes, pictures, video, or other objects to a user. The device 100 further comprises a user input device 106 coupled to the processor 102. The user input device 106 may be, for example, a keyboard, a mouse, a touchpad or other input devices.

As shown, the device 100 further comprises a reader/writer 120 coupled to the processor 102. In at least some embodiments, the reader/writer 120 is an optical drive that reads or writes optical disks. Alternatively, the reader/writer 120 may be, for example, a hard drive, a tape drive or some other reader/writer 120 now known or later developed.

As shown in FIG. 1, the reader/writer 120 comprises a positioning mechanism 122. The positioning mechanism 122 corresponds to hardware components involved with positioning the reader/writer 120. For example, the positioning mechanism 122 could enable the reader/writer 120 to pivot and/or to slide between an internal storage position and an external operational position. The positioning mechanism 122 could involve manual force, electro-mechanical force or a combination of both. In at least some embodiments, the positioning mechanism 122 comprises a lever or other handle that enables a user to manually position the reader/writer 120. Additionally or alternatively, the positioning mechanism 122 comprises positioning control logic that directs hardware components to position the reader/writer 120 based on control signals. The control signals could be user-activated (e.g., if a user presses a button, touches a lever, selects a reader/writer protract function, or selects a reader/writer retract function) or device-activated (e.g., an application being executed requests a reader/writer protract function or a reader/writer retract function). In at least some embodiments, the positioning control logic responds to the control signals by operating an electric motor or other hardware components configured to position the reader/writer 120 in the internal storage position or the external operational position. In at least some embodiments, the positioning mechanism 122 physically supports the weight of the reader/writer 122 while in the operational position. The positioning mechanism 122 could also support the weight of the storage medium associated with the reader/writer 122.

The reader/writer 120 also comprises read/write hardware (HW) 124. The read/write HW 124 corresponds to hardware components involved with reading from a storage medium or writing to a storage medium. In at least some embodiments, the read/write HW 124 comprises read/write control logic that directs hardware components to perform read or write operations based on control signals. The control signals could be user-activated (e.g. if a user enters a read or write request via the user input device 106) or device-activated (erg, if an application being executed requests a read or write operation). In response to the control signals, the read/write control logic operates hardware that reads from or writes to a storage medium. For example, if the reader/writer 120 is an optical drive, the read/write control logic is able to operate a laser lens, a spindle motor, an optical pickup unit, a damper, or other hardware involved with reading from or writing to an optical disk.

The reader/writer 120 also comprises a hold/release mechanism 126. The hold/release mechanism 126 corresponds to hardware involved with holding and releasing a storage medium. While the storage medium is “held,” the reader/writer 120 is able to perform read or write operations. Also, removal of the storage medium or disruption of the storage medium during a read or write operation is prevented or is otherwise made difficult. While the storage medium is “released,” the reader/writer 120 cannot perform read or write operations. Also, a user is able to remove a storage medium from the reader/writer 120. Another storage medium can then be placed in the reader/writer or the reader/writer 120 can be placed in the internal storage position. In at least some embodiments, the hold/release mechanism 126 comprises hold/release control logic that directs hardware components to hold or release a storage medium based on control signals. The control signals could be user-activated (e.g., if a user presses a button, touches a lever, requests a hold function or requests a release function) or device-activated (e.g., if an application being executed requests a hold function or a release function). In response to the control signals, the hold/release control logic operates hardware that holds a storage medium or releases a storage medium. As an example, if the hold/release mechanism 126 comprises at least one support arm that selectively holds and releases an optical disk, the hold/release control logic may move the at least one support arm to selectively hold or release the optical disk. In different embodiments, the hold/release mechanism 126 can be operated based on manual force, electro-mechanical force or a combination of both.

In at least some embodiments, the reader/writer 120 comprises at least one support arm without a reader/writer housing (i.e. other than the computer system chassis, the support arm lacks another housing or enclosure). In this manner, the reader/writer 120 is sized and shaped to diminish the amount of space which the reader/writer 120 occupies within the chassis while in the internal storage position.

As shown in FIG. 1, the device 100 also comprises a storage (system memory) 108 coupled to the processor 102. The storage 108 comprises a computer-readable medium such as volatile storage (e.g., random access memory), non-volatile storage (e.g., hard disk drive), CD-ROM, DVD-ROM, “flash” memory or a combination thereof. The storage 108 stores instructions (a “driver”) that enable the reader/writer 120 to function. For example, in at least some embodiments, the storage 108 stores read/write instructions 110, positioning instructions 112 and hold/release instructions 114 which are executable by the processor 102. The storage 108 also may store other instructions or applications executable by the processor 120. At least some of these applications may request that the reader/writer 120 perform a read or write operation. Also, at least some of these applications may display images on the display 104 based on reads performed by the reader/writer 120.

When executed, the read/write instructions 110 cause the reader/writer 120 to read from or write to a storage medium. In at least some embodiments, the read/write instructions 110 support a predetermined read protocol or a predetermined write protocol compatible with the reader/writer 120 and the storage medium. As an example, if the reader/writer 120 receives a request to read data from a storage medium, the read/write instructions 110 enable verification and activation of the read/write HW 124. In some embodiments, the read/write instructions 110 enable some or all of the control signals to be provided to the read/write control logic previously mentioned. For example, the read/write instructions 110 may cause the processor 102 to monitor and process input signals (user-controlled, application-controlled or both) and to generate control signals for the read/write control logic accordingly.

In some embodiments, the read/write instructions 110 enable a file or memory space to be prepared in the storage 108 for receiving data read from the storage medium via the reader/writer 120. The read/write instructions 110 also enable the processor 102 to determine when a read operation is completed or interrupted. In response to a completed or interrupted read operation, the read/write instructions 110 enable additional functions such as reads, writes, interrupt handling, error logging, error correction, re-starting a read, de-activating the read/write HW 124 or other operations.

If the reader/writer 120 receives a request to write data to a storage medium, the read/write instructions 110 may enable verification and activation of the read/write HW 124. Again, the read/write instructions 110 enable some or all of the control signals to be provided to the read/write control logic previously mentioned. The read/write instructions 110 also access a file or memory space in the storage 108 and transfer data from the file or memory space to the storage medium via the reader/writer 120. The read/write instructions 110 also enable the processor 102 to determine when a write operation is completed or interrupted. In response to a completed or interrupted write operation, the read/write instructions 110 enable additional functions such as reads, writes, interrupt handling, error logging, error correction, re-starting a write, de-activating the read/write HW 124 or other operations.

When executed, the positioning instructions 112 enable the reader/writer 120 to position itself in an external operational position or in an internal storage position. In some embodiments, the positioning instructions 112 enable some or all of the control signals to be provided to the positioning control logic previously mentioned. For example, the positioning instructions 112 may cause the processor 102 to monitor and process input signals (user-controlled, application-controlled, or both) and to generate control signals for the positioning control logic accordingly. The positioning instructions 122 also may enable functions such as determining if the reader/writer 120 is unable to be placed in the external operational position or in the internal storage position and determining if the reader/writer 120 has successfully been placed in the external operational position or in the internal storage position.

When executed, the hold/release instructions 114 cause the reader/writer 120 to hold or release a storage medium. In some embodiments, the hold/release instructions 114 enable some or all of the control signals to be provided to the positioning control logic previously mentioned. For example, the hold/release instructions 114 may cause the processor 102 to monitor and process input signals (user-controlled, application-controlled or both) and to generate control signals for the hold/release control logic accordingly.

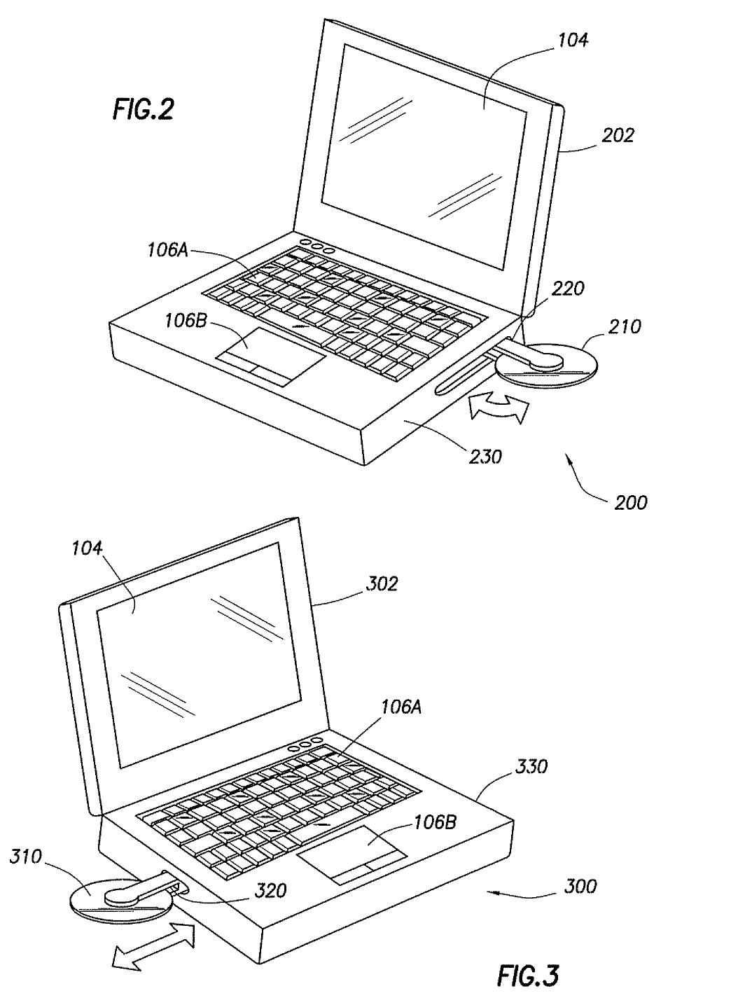

FIG. 2 shows a system 200 in accordance with embodiments. As shown in FIG. 2, the system 200 comprises a laptop computer 202 having a display 104 and input devices 106A (e.g., a keyboard) and 106B (e.g., a touchpad). The laptop computer 202 also comprises a reader/writer 220 having the same or similar functions described for the reader/writer 120 of FIG. 1. The reader/writer 220 is able to pivot from an internal storage position to an external operational position and vice versa. In FIG. 2, the reader/writer 220 has been pivoted to the external operational position and is able to read from or write to a storage medium 210. In at least some embodiments, the reader/writer 220 comprises an optical drive and the storage medium 210 comprises an optical disk.

As no longer needed, the reader/writer 220 is pivoted to the internal storage position within the chassis or housing 230 of the laptop computer 202. In such case, the storage medium 210 is released before the reader/writer 220 is pivoted to the internal storage position.

FIG. 3 shows another system 300 in accordance with embodiments. As shown in FIG. 3, the system 300 comprises a laptop computer 302 having a display 104 and input devices 106A (ergo a keyboard) and 106B (e.g., a touchpad). The laptop computer 302 also comprises a reader/writer 320 having the same or similar functions described for the reader/writer 120 of FIG. 1. The reader/writer 320 is able to slide (protract/retract) from an internal storage position to an external operational position and vice versa. In FIG. 3, the reader/writer 320 has been protracted to the external operational position and is able to read from or write to a storage medium 310. In at least some embodiments, the reader/writer 320 comprises an optical drive and the storage medium 310 comprises an optical disk.

As no longer needed, the reader/writer 320 is retracted to the internal storage position within the chassis or housing 330 of the laptop computer 302. In such case, the storage medium 310 is released before the reader/writer 320 is retracted to the internal storage position.

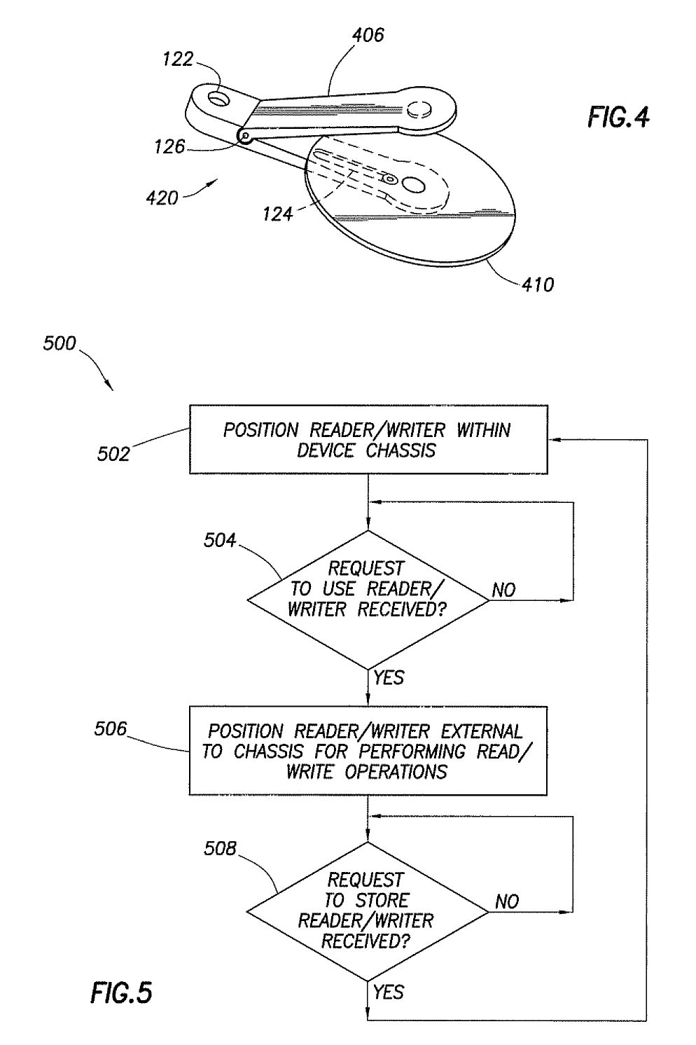

FIG. 4 shows an optical drive 420 in accordance with embodiments. The optical drive 420 may have the same or similar functions described for the reader/writer 120 of FIG. 1. As shown in FIG. 4, the optical drive 420 comprises a positioning mechanism 122 that enables the optical drive 420 to change positions between an internal storage position and an external operational position. The positioning mechanism 122 shown in FIG. 4 is simplified for convenience and is not intended to limit embodiments to any particular positioning mechanism. As previously described, a positioning mechanism could enable a reader/writer such as the optical drive 420 to pivot and/or to slide between the internal storage position and the external operational position. Also, a positioning mechanism could involve manual force, electro-mechanical force or a combination of both. In at least some embodiments, the positioning mechanism 122 physically supports the weight of the optical drive 420 and the optical disk 410 while in an operational position.

The optical drive 420 also comprises read/write hardware (HW) 124. The read/write HW 124 corresponds to hardware components involved with reading from a storage medium or writing to a storage medium. The read/write HW 124 shown in FIG. 4 is simplified for convenience and is not intended to limit embodiments to any particular hardware component or hardware arrangement. For a reader/writer such as the optical drive 420, the read/write HW 124 may comprise a laser lens, a spindle motor, an optical pickup unit, a damper, or other hardware involved in an optical read/write process.

The optical drive 420 also comprises a hold/release mechanism 126. The hold/release mechanism 126 enables the optical drive 420 to selectively hold and release an optical disk 410. As shown, the hold/release mechanism 126 may enable a support arm 406 to open (releasing the optical disk 410) or close (holding the optical disk 410). The hold/release mechanism 126 shown in FIG. 4 is simplified for convenience and is not intended to limit embodiments to any particular hold/release mechanism.

As shown in FIG. 4, the optical drive 420 does not have a housing or enclosure. In other words, the optical drive components (i.e., the positioning mechanism 122, the read/write HW 124 and the hold/release mechanism 126) are either within a device chassis or are unenclosed external to the device chassis. In this manner, the optical drive 420 is sized and shaped to diminish the amount of space which the optical drive 420 occupies within a device chassis.

FIG. 5 illustrates a method 500, in accordance with embodiments, that comprises positioning a reader/writer within a device chassis or housing (block 502). In at least some embodiments, the reader/writer is an optical drive. The method 500 further comprises waiting until a request to use the reader/writer is received (determination block 504). The request to use the reader/writer may be user-controlled, application-controlled, or both. For example, the request to use the reader/writer may involve manual force, signals from a user input device, or signals from an application being executed by the device (e.g., the laptop) associated with the reader/writer. If a request to use the reader/writer is received (determination block 504), the reader/writer is positioned external to the device chassis or housing for performing read/write operations (block 506). The read/write operations involve a storage medium compatible with the reader/writer and located external to the device chassis or housing.

The method 500 further comprises waiting for a request to store the reader/writer (determination block 508). The request to store the reader/writer may be user-controlled, application-controlled, or both. For example, the request to store the reader/writer may involve manual force, signals from a user input device, or signals from an application being executed by the device (e.g., the laptop) associated with the reader/writer. If a request to store the reader/writer is received (determination block 508), the method 500 positions the reader/writer within the device chassis or housing (block 502). In at least some embodiments, the storage medium is released from the reader/writer before positioning the reader/writer within the device chassis or housing.

The above discussion is meant to be illustrative of the principles and various embodiments of the present invention. Numerous variations and modifications will become apparent to those skilled in the art once the above disclosure is fully appreciated. For example, a reader/writer could be manually stored within a compartment or slot of a device chassis and placed into the external operational position by plugging the reader/writer into a corresponding port. It is intended that the following claims be interpreted to embrace all such variations and modifications.

What is claimed is:

1. A computer system, comprising:
a chassis; and
a reader/writer selectively positionable between a storage position inside the chassis and an operational position outside the chassis.

2. The computer system of claim 1 wherein the reader/writer performs at least one of a read operation and a write operation while positioned outside the chassis.

3. The computer system of claim 1 wherein the reader/writer comprises an optical drive.

4. The computer system of claim 3 wherein the optical drive comprises a support arm and wherein the support arm maintains a disk while the optical drive performs at least one of a read operation and a write operation.

5. The computer system of claim 3 wherein the optical drive comprises a support arm without a housing and wherein the support arm maintains a disk while the optical drive performs at least one of a read operation and a write operation.

6. The computer system of claim 1 wherein the reader/writer has a hold/release mechanism that enables the reader/writer to selectively hold and release a storage medium.

7. The computer system of claim 6 wherein the hold/release mechanism comprises at least one of a manually-controlled mechanism and an electro-mechanically controlled mechanism.

8. The computer system of claim 1 wherein the reader/writer has a positioning mechanism that enables the reader/writer to switch between the internal storage position and the external operational position.

9. The computer system of claim 8 wherein the positioning mechanism pivots the reader/writer between the internal storage position and the external operational position.

10. The computer system of claim 8 wherein the positioning mechanism slides the reader/writer between the internal storage position and the external operational position.

11. The computer system of claim 8 wherein the positioning mechanism comprises at least one of a manually-controlled mechanism and an electro-mechanically controlled mechanism.

12. The computer system of claim 8 wherein the positioning mechanism supports a weight of the reader/writer while in the operational position.

13. The computer system of claim 8 wherein the positioning mechanism supports a weight of a storage medium associated with the reader/writer while in the operational position.

14. A data reader/writer, comprising:
positioning hardware that enables the reader/writer to be selectively positionable between a storage position within a device chassis and an operational position external to the device chassis; and
read/write hardware that enables the reader/writer to read from or write to a storage medium while in the operational position.

15. The reader/writer of claim 14 wherein the reader/writer further comprises hold/release hardware that selectively holds and releases the storage medium.

16. The reader/writer of claim 14 wherein the reader/writer comprises an optical drive and the storage medium comprises an optical disk.

17. A method, comprising:
selectively positioning a reader/writer within a device chassis;
selectively positioning the reader/writer outside the device chassis; and
performing at least one of a read operation and a write operation while the reader/writer is positioned outside the device chassis.

18. The method of claim 17 further comprising releasing a storage medium from the reader/writer before positioning the reader/writer within the device chassis.

19. The method of claim 18 further comprising holding a storage medium, by the reader/writer, before performing at least one of the read operation and the write operation.

20. A computer-readable medium containing instructions that, when executed by a processor, causes the processor to:
selectively position a reader/writer between a storage position inside a device chassis and an operational position outside the device chassis.

21. The computer-readable medium of claim 20 wherein the instructions further cause the processor to selectively control read/write hardware of the reader/writer while the reader/writer is in the operational position.

22. The computer-readable medium of claim 20 wherein the instructions further cause the processor to selectively control a storage medium hold/release mechanism of the reader/writer while the reader/writer is in the operational position.
